(19) United States
(12) Patent Application Publication
(10) Pub. No.: US 2005/0138826 A1
(43) Pub. Date: Jun. 30, 2005

(54) Manual stud detector with needle (aka: Acu-Stud)

(76) Inventors: Yung-Hui Hsieh, Malibu, CA (US); Yau-Mei Cho Hsieh, Malibu, CA (US)

Correspondence Address: Yung-Hui Hsieh, 11378 Tonga St., Malibu, CA, 90265, US

(21) Appl. No.: 10/746,636

(22) Filed: Dec. 29, 2003

(51) Int. Cl. G01B 5/00

(52) U.S. Cl. 33/542

(57) ABSTRACT

The Manual Stud Detector with Needle (aka: Acu-Stud) accurately detects the location of studs behind the wall so that the user can identify optimal locations to drive in nails/screws for hanging pictures, shelves, electronics, hardware, and the sorts. This device uses a thin needle, similar to the needle used for acupuncture, to punch thru the wall surface without damaging the drywall. Studs behind the wall surface can actually be “felt” with this device, as the structure provides resistance to the user. The needle automatically retracts, and the device is restored to its original position via the internal spring. The only limitation to this device is that the surface being punctured must be softer than the stud material behind the surface. Drywall and soft wood are the optimal surfaces for using this device.

### BACKGROUND OF INVENTION

In the realm of interior decorating, it is important to accurately find the location of the studs behind a wall in order to safely hang portraits, shelves, electronics, hardware, etc. In the past, many electronic stud detectors have been rather inaccurate, as they often mistaken pipes and various irregular obstructions as studs. This has been rather frustrating for the end-users.

### BRIEF SUMMARY OF INVENTION

The purpose of the “Acu-Stud” is to accurately detect the location of studs behind the wall so that the user can identify optimal locations to drive in nails/screws for hanging pictures, shelves, electronics, hardware, etcs. This device uses a thin needle, similar to the needle used for acupuncture, to punch thru the wall surface without damaging the drywall. Studs behind the wall surface can actually be “felt” with this device, as the structure provides resistance to the user. The Acu-Stud is basically used as a tool for interior decorations, and is most effective when used on walls that are made of materials softer than natural wood.

### DESCRIPTION OF DRAWINGS

We, Yung-Hui Hsieh & Yau-Mei Cho Hsieh, have invented a new device titled Manual Stud Detector with Needle (aka: Acu-Stud), as set forth in the following specifications (see attached illustrations).

FIG. 1 is a top-diagonal view of the Acu-Stud;

FIG. 2 is the horizontal cross-section view with all components labeled;

FIG. 3 is the horizontal cross-section view of component (A);

FIG. 4 is the front view of component (A);

FIG. 5 is the side view of component (B);

FIG. 6 is the side view of component (C);

FIG. 7 is the side view of component (E);

FIG. 8 is the side view of component (D);

FIG. 9 is the horizontal cross-section view of component (F);

FIG. 10 is the front view of component (F);

FIG. 11 is the side view of component (G);

FIG. 12 is the side view of component (H)

Product Configuration: This device contains two distinct parts and one spring.

Section 1 contains components A, B, C, H.
Section 2 contains components D, E, F.
The Spring is component G.

### DETAILED DESCRIPTION OF INVENTION

Directions of Usage:

The user shall use one hand (left or right) to hold the device similar to using a syringe, with forefinger and middle-finger anchoring the side “hooks”. The portion of the palm closest to the base of the thumb is flatly pressed against component (A) of Part #1. Component (F) of Part #2 is then pressed against the drywall, making the device perpendicular to the wall. Variable arm force is applied to component (A), causing the device to shorten. As Part #1 and Part #2 are brought closer together (similar to the piston of a syringe), the thin needle protrudes outward and punches into the drywall. If the needle touches a stud behind the drywall, the user's hand will feel resistance. Otherwise, the needle will go straight through approximately 2″ deep with no resistance. As the needle retracts, the device is restored to its original position via the internal spring.

Manufacturing/Fabrication:

There are a total of eight (8) components in this device, divided into two (2) key sections. Section 1 includes components (A), (B), (C) and (H). Section 2 includes components (D), (E) and (F). Component (G) is the internal spring. All plastic parts are molded via traditional plastic manufacturing protocols.

Component (A) is a circular disc made of hard plastic covered with a thin rubber layer. It is permanently attached at the base to component (B), which is a plastic hollow tube with 2 exterior finger “hooks”. Component (C) is also a plastic hollow tube, but it fits inside (B) and is permanently attached to (A). Component (H) is a thin, metal needle with a small, circular base that fits inside (C) and is screwed into (A) at the base. The needle is replaceable should it be damaged during usage. Component (H) can be detached at the base. This completes section 1.

Components (D), (E) and (F) form section 2, which is essentially a smaller version of section 1 with the exception that (F) has a hole in the center exactly where the needle is attached in section 1. Section 2 fits perfectly into section 1, thus allowing the device to contract and expand. The metal spring (G) is attached to the base of (H), and allows the device to return to original position when no force is applied.

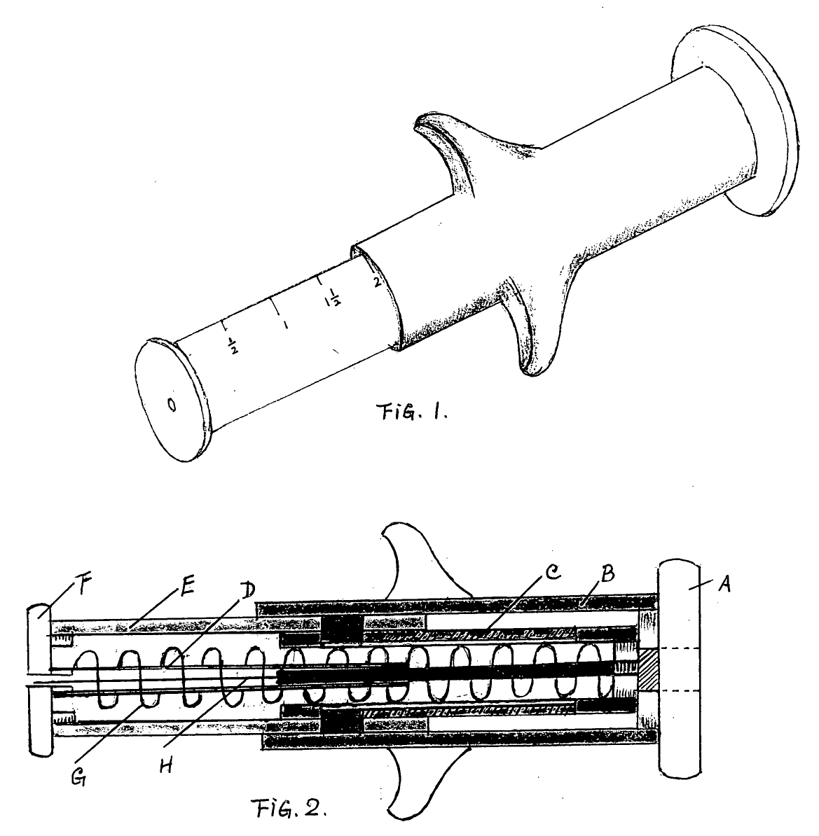

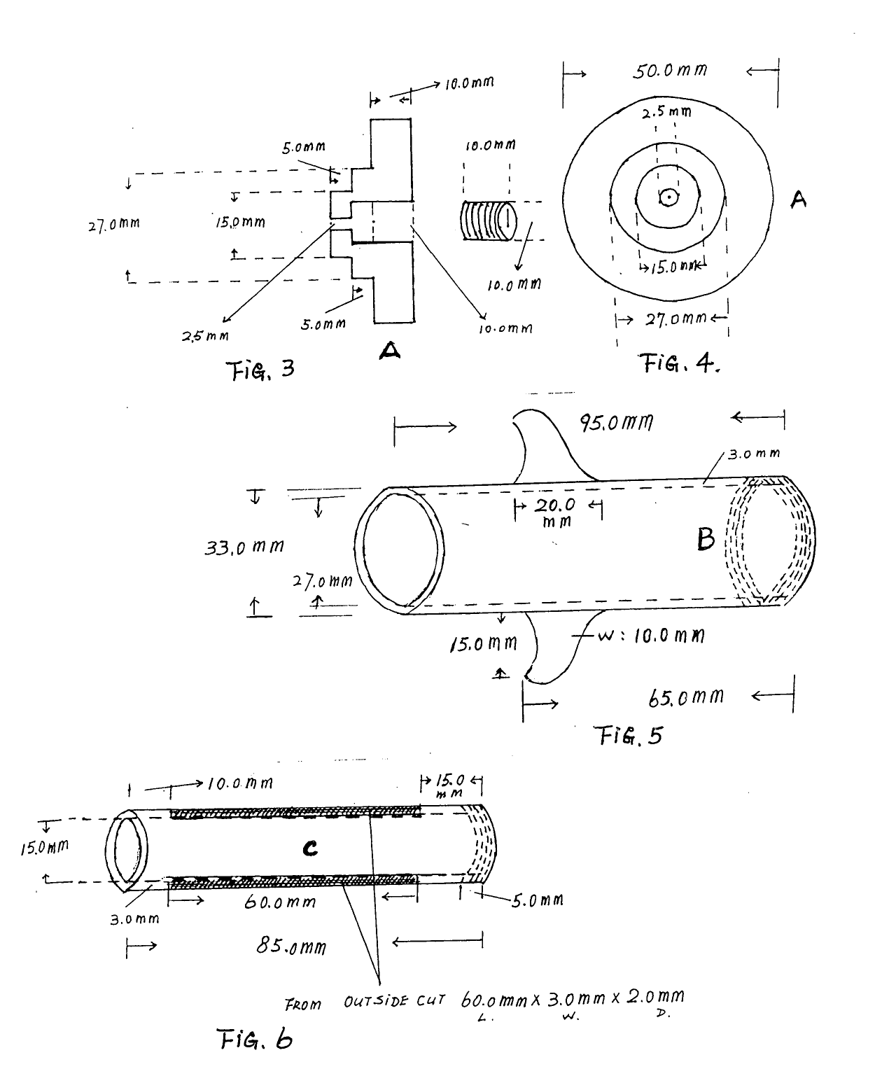

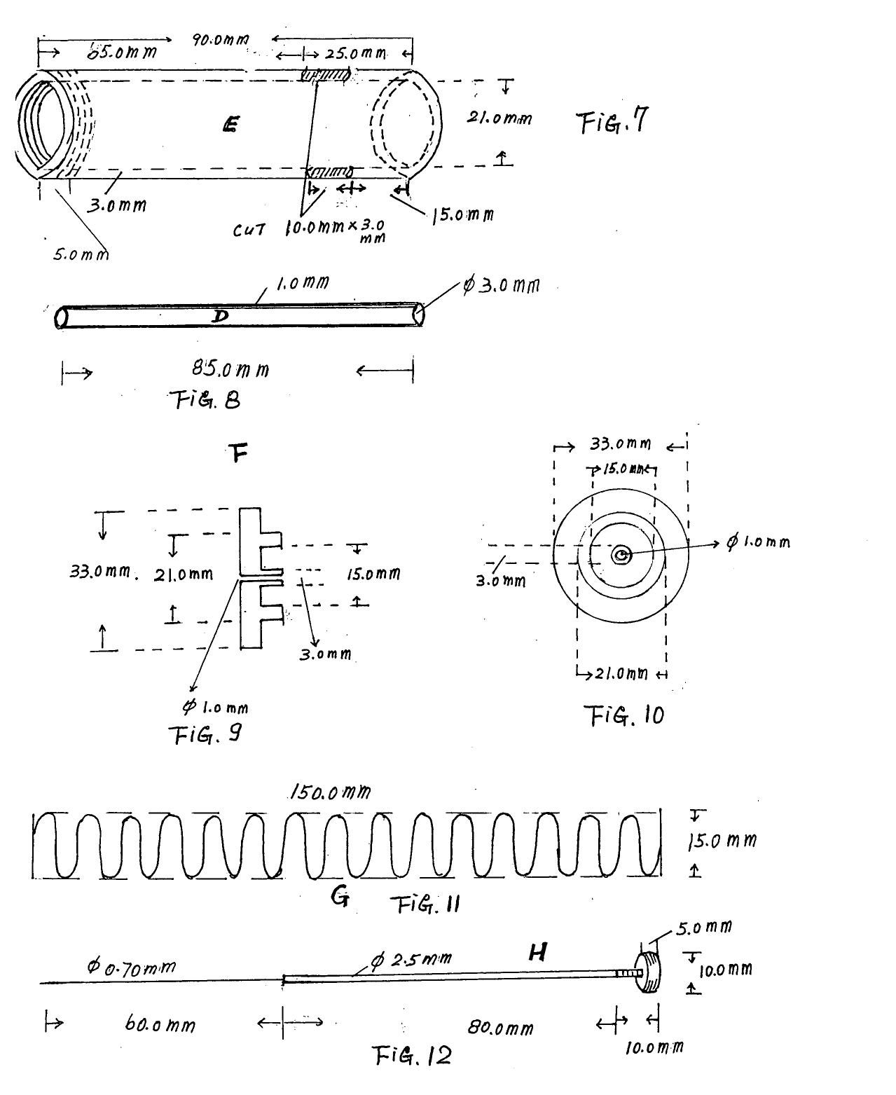

1) The invention of the Manual Stud Detector with Needle (aka: Acu-Stud) is original, and is designed to precisely locate hidden studs behind interior walls by utilizing the needle and other mechanisms specified in the attached illustrations (FIG. 1-12).

2) The stud behind the wall surface can actually be “felt” with this device, as the structure of the stud provides resistance against the needle of the device.

3) This device uses a thin needle, similar to the needle used for acupuncture, to punch thru the wall surface without damaging the surface of the wall.
